(19) United States
(12) Patent Application Publication
(10) Pub. No.: US 2026/0158827 A1
(43) Pub. Date: Jun. 11, 2026

(54) PNEUMATIC VEHICLE TIRE

(71) Applicant: Continental Reifen Deutschland GmbH, Hannover (DE)

(72) Inventors: Stefan Rittweger, Garbsen (DE); Juraj Jurco, Hannover (DE)

(73) Assignee: Continental Reifen Deutschland GmbH, Hannover (DE)

(21) Appl. No.: 18/707,960

(22) PCT Filed: Sep. 6, 2022
(86) PCT No.: PCT/DE2022/200206

§ 371 Date: May 7, 2024

(30) Foreign Application Priority Data
Nov. 8, 2021 (DE) 10 2021 212 508.5

(51) Int. Cl. B60C 13/00; B60C 13/02

(52) U.S. Cl. CPC B60C 13/001; B60C 13/02

(57) ABSTRACT

The invention relates to a pneumatic vehicle tire comprising at least one surface element (2) formed on its outer surface with a peak-and-trough contrast structure (6) formed relative to a base level (NB) and covering the surface.

The peak-and-trough contrast structure (6) is formed from a plurality of contrast structure cells (7) joined together in a grid pattern and having matching forms in top view,
wherein the peak-and-trough contrast structure (6) has grid-defining troughs (6a) along the mutual connection points of the contrast structure cells (7),
wherein the contrast structure cells (7) each have an irregular peak-and-trough structure (8) which covers the surface, extends up to the grid-defining troughs (6a) and is made solely of a single cohesive branched peak structure (8a) and closed-ended troughs (8b) projecting from the grid-defining troughs (6a),
wherein the arrangement of the contrast structure cells (7) and the design of the irregular peak-and-trough structures (8) are such that, viewed from above, the irregular peak-and-trough structures (8) can be transferred into one another by congruent projection.

### CROSS-REFERENCE TO RELATED APPLICATIONS

The present application is a National Stage Application under 35 U.S.C. § 371 of International Patent Application No. PCT/DE 2022/200206 filed on Sep. 6, 2022, the disclosures of which are herein incorporated by reference in their entireties.

### BRIEF SUMMARY

The invention relates to a pneumatic vehicle tire comprising at least one surface element formed on its outer surface with a peak-and-trough contrast structure formed relative to a base level and covering the surface.

It is known to form surface elements with a contrast structure on the outer surface of pneumatic vehicle tires, in particular on sidewalls, the primary purpose of which elements is to create a contrast with other, in particular unstructured surface regions, in order, for example, to make it easier to distinguish symbols on the sidewalls, e.g. design elements or logos. Surface elements with contrast structures make this possible since-in comparison with smooth surfaces-they reflect less light, i.e. they “capture” incident light and therefore appear darker to the observer than smooth surface regions.

At present, tires mainly have regular contrast structures comprising a plurality of mutually parallel ribs which amplify light at certain observation angles and give little or no reflection at certain other viewing angles, so the contrast effect is not optimal. Furthermore, with regular contrast structures, for good contrast effect the orientation of the ribs must be matched to the shape of the respective surface element.

As well as regular contrast structures, also irregular peak-and-trough contrast structures are increasingly known, which have “finer” structures than ribs, i.e. significantly smaller peak-like protrusions and/or hole-like depressions. These are introduced into the mold parts of the tire heating molds, in particular by laser engraving, and embossed into the tire during vulcanization.

A pneumatic vehicle tire of the type cited above is known, for example, from WO 2020 239 305 A1. On its outer surface, the tire has at least one surface element with a peak-and-trough contrast structure which is irregular over its entire extent and covers the surface, and has a surface-related roughness value Sₐ to EN ISO 25178 of 50 μm to 150 μm and a height of 400 μm to 500 μm determined relative to the base level at its highest point(s). The irregular peak-and-trough contrast structure captures light in a fashion which is advantageous for the contrast effect against smooth surface areas.

A further tire of the type cited initially is known from FR 3 075 099 A1. The tire has a tread and sidewalls, wherein at least one surface element with an irregular peak-and-trough contrast structure covering the surface is formed on the tread and/or on at least one sidewall. The peak-and-trough contrast structure has a plurality of peak tips which are present irregularly in a density of at least one tip per square millimeter and at most one hundred tips per square millimeter. In the region of the peak tips, the peak-and-trough contrast structure has a maximum height of 50 μm to 600 μm, preferably 100 μm to 400 μm, and particularly preferably 200 μm to 350 μm. This contrast structure allows a good contrast effect irrespective of observation angle.

Irregular peak-and-trough contrast structures are superior in contrast effect to regular contrast structures because of the largely direction-independent light reflection, and in addition are significantly more versatile in use, since in comparison with even contrast structures having ribs, the orientation of the peak-and-trough contrast structure plays little or at least only a subordinate role in the contrast effect. However, completely irregular contrast structures can only be formed on large surface areas-as desirable or necessary for example on the sidewalls of tires-by means of extremely costly laser engraving.

The invention is therefore based on the object of providing, in a tire of the type cited initially, a contrast structure of easily scalable size with an at least largely direction-independent contrast effect.

This object is achieved according to the invention in that
the peak-and-trough contrast structure is formed from a plurality of contrast structure cells joined together in a grid pattern and having matching forms in top view,
wherein the peak-and-trough contrast structure has grid-defining troughs along the mutual connection points of the contrast structure cells,
wherein the contrast structure cells each have an irregular peak-and-trough structure which covers the surface, extends up to the grid-defining troughs and is made solely of a single cohesive branched peak structure and closed-ended troughs projecting from the grid-defining troughs,
wherein the arrangement of the contrast structure cells and the design of the irregular peak-and-trough structures are such that, viewed from above, the irregular peak-and-trough structures can be transferred into one another by congruent projection.

As a result of the repetition (replication) of such contrast structure cells, the contrast structure is scalable as desired in terms of size and is therefore highly suitable for surface regions of different sizes. In particular, for example on the sidewalls of vehicle tires, large surface elements can easily be provided with a contrast structure having the advantages of a totally irregular structure. The irregular peak-and-trough structures are each composed exclusively of a single cohesive peak structure and close-ended troughs each projecting from a “trough grid”, which achieves a direction-independent and particularly intense contrast effect. The repetition is evident only at a very short distance. The particularly intense contrast effect is achieved by the fact that the irregular peak-and-trough structure can be produced in an at least substantially flawless state during vulcanization, as will be explained below. The contrast structure is formed in particular by a vulcanization mold with one or more molding parts with corresponding laser engraving on the inside. Because of the cohesive peak structure, the laser engraving has only a single lasered irregular “notch structure” forming the peak structure. The corresponding rubber mixture can be molded particularly readily in such a notch structure during vulcanization, so that the notch structure is completely, or substantially completely, filled with rubber mixture. As a result, air inclusions are avoided and the vulcanization mold can be vented completely, or substantially completely, in the region of the laser engraving so that the irregular peak-and-trough structure is produced in a flawless state.

According to a first preferred embodiment, the peak structure has exclusively crossing points at which portions of the peak structure coming from three directions meet one another. This allows a particularly clearly structured, simple peak structure which can therefore be produced in high quality.

In the first preferred embodiment, it is advantageous if the crossing points are T-shaped or Y-shaped in top view. This contributes to a particularly clear (unambiguous) peak structure, which improves the contrast effect in particular when the contrast structure is used over a large area, e.g. on sidewalls.

In connection with the first preferred embodiment, it is furthermore advantageous if the peak structure has three to seven crossing points. In particular, the complexity of such a peak structure is such that it can be produced in excellent quality and at the same time show a very high contrast effect.

According to a further preferred embodiment, in top view, the contrast structure cells are each delimited by a number of straight grid lines or a number of straight portions of grid lines, wherein the grid lines or portions of grid lines run in the grid-defining troughs and wherein the contrast structure cells preferably each have an edge length relating to an adjoining grid line or adjoining portion of a grid line of 700.0 μm to 1300.0 μm, in particular 800.0 μm to 1200.0 μm.

This helps make the contrast structure easily scalable in size.

A further preferred embodiment is characterized in that the closed-ended troughs each project from a single grid-codefining trough. In this way, the troughs can be designed very simply while improving the contrast effect, in particular with respect to a direction-independent contrast effect.

A further preferred embodiment is characterized in that the peak-and-trough structure, with a height surface region extending over the contrast structure cell, of a height surface which extends parallel to the base level and lies relative thereto at a height of 20% of the maximum height of the peak structure determined perpendicularly to the base level, has a one-piece section surface which takes up 70% to 80% of the height surface region.

According to a preferred variant of the last-mentioned preferred embodiment, it is provided that the closed-ended troughs in the height surface region each have a trough surface which adjoins the one-piece section surface and is co-delimited, against the grid-codefining trough from which the respective closed-ended trough projects, by a grid parallel line resulting from a minimum possible parallel shift of the grid line which runs in the grid-codefining trough from which the respective closed-ended trough projects, wherein the size of the largest trough surface amounts to 105% to 170%, in particular maximum 150%, preferably maximum 130% of the size of the smallest trough surface. The sizes of the trough surfaces therefore deviate from one another only to a limited extent so that in this respect, the peak-and-trough structure has a certain regularity which further improves the contrast effect with respect to its directional independence.

In the last-mentioned preferred variant, it is preferred if the trough surfaces have minimum possible straight measured distances from one another of 80.0 μm to 100.0 μm.

A further preferred embodiment is characterized in that the peak-and-trough structure, with a height surface region extending over the contrast structure cell, of a height surface which extends parallel to the base level and lies relative thereto at a height of 40% of the maximum height of the peak structure determined perpendicularly to the base level, has a one-piece section surface which takes up 40% to 60% of the height surface region. The peak structure is therefore also cohesive at this height, which is further advantageous for the contrast effect.

According to a preferred variant of the last-mentioned preferred embodiment, it is provided that the closed-ended troughs in the height surface region each have a trough surface which adjoins the one-piece section surface and is co-delimited, against the grid-codefining trough from which the respective closed-ended trough projects, by a grid parallel line resulting from a minimum possible parallel shift of the grid line which runs in the grid-codefining trough from which the respective closed-ended trough projects, wherein the trough surfaces have minimum possible straight measured distances from one another of 60.0 μm to 80.0 μm.

According to a further preferred embodiment, it is provided that the peak-and-trough structure, with a height surface region extending over the contrast structure cell, of a height surface which extends parallel to the base level and lies relative thereto at a height of 60% of the maximum height of the peak structure determined perpendicularly to the base level, has a one-piece section surface which takes up 20% to 30% of the height surface region. The peak structure is therefore also cohesive at this height, which is further advantageous for the contrast effect.

According to a preferred variant of the last-mentioned preferred embodiment, it is provided that the closed-ended troughs in the height surface region each have a trough surface which adjoins the one-piece section surface and is co-delimited, against the grid-codefining trough from which the respective closed-ended trough projects, by a grid parallel line resulting from a minimum possible parallel shift of the grid line which runs in the grid-codefining trough from which the respective closed-ended trough projects, wherein the trough surfaces have minimum possible straight measured distances from one another of 40.0 μm to 50.0 μm.

Preferably, the peak structure has a maximum height of 200.0 μm to 400.0 μm determined relative and perpendicular to the base level.

According to a further preferred embodiment, the peak-and-trough structure has at least two, in particular at least three closed-ended troughs projecting from the grid-defining troughs. This contributes above all to further improving the direction-independent contrast effect.

### BRIEF DESCRIPTION OF THE SEVERAL VIEWS OF THE DRAWINGS

Further features, advantages and details of the invention will now be described in more detail with reference to the drawing, which schematically shows an exemplary embodiment of the invention. In the drawing:

FIG. 1 shows a schematic plan view of a circumferential portion of a sidewall of a pneumatic vehicle tire with a design variant of the invention,

FIG. 2 shows a schematic, enlarged plan view of a part region of a surface element formed on the sidewall,

FIG. 3 shows a further enlarged, schematic, oblique view of a contrast structure cell belonging to the surface element from FIG. 2 and having a peak-and-trough structure,

FIG. 4 is a processed microscope image showing a top view of the contrast structure cell from FIG. 3, wherein the peak-and-trough structure is cut along a height surface F₁ (FIG. 3),

FIG. 5 is a microscope image similar to that of FIG. 4, wherein the peak-and-trough structure is cut along a height surface F₂ (FIG. 3),

FIG. 6 is a microscope image similar to that of FIG. 4, wherein the peak-and-trough structure is cut along a height surface F₃ (FIG. 3),

FIG. 7 is a microscope image similar to that of FIG. 4, wherein the peak-and-trough structure is cut along a height surface F₄ (FIG. 3).

### DETAILED DESCRIPTION

The invention concerns surface elements which are formed on the outer surface of a pneumatic vehicle tire. At least one such surface element is formed on the outer surface.

The surface elements may be formed on the outer surface in a region which does not—or not over a large area—come into contact with the ground during use of the vehicle tire; in particular on a sidewall, on the tread edge, i.e. on the shoulder flanks running to the sidewalls outside the contact patch, or on groove flanks and/or groove bases of grooves running in the tread. As a particular preference, the surface elements are formed on sidewalls. Sidewalls generally contain characters which give prescribed information, such as dimensional data, speed index, manufacturer or purpose (summer/winter tires), or other characters such as logos or design elements. The surface elements may surround said characters on the sidewall or may themselves form the characters.

The surface elements may furthermore be formed on the tread, i.e. on the region of the outer surface of the vehicle tire which comes into contact with the ground during use.

The surface elements each have a specific peak-and-trough contrast structure and are preferably produced during vulcanization of the vehicle tire. The mold segments of the vulcanization mold, e.g. the side shells, are each provided with a laser engraving corresponding to the peak-and-trough contrast structure of the surface element. Alternatively, the peak-and-trough contrast structure may be laser-engraved onto the finished vulcanized tire.

The peak-and-trough contrast structure is formed on and relative to a base level N_{B} and comprises rubber material protruding from the base level N_{B}.

If for example a side shell is provided with laser engraving, the base level N_{B} is the level of the outer surface of the sidewall. If a protrusion formed on the side shell is provided with laser engraving, the base level N_{B} is the level of the base of a flat depression formed on the sidewall and corresponding to the protrusion, so that the base level N_{B} is offset towards the tire interior relative to the unengraved level surrounding the base level N_{B}.

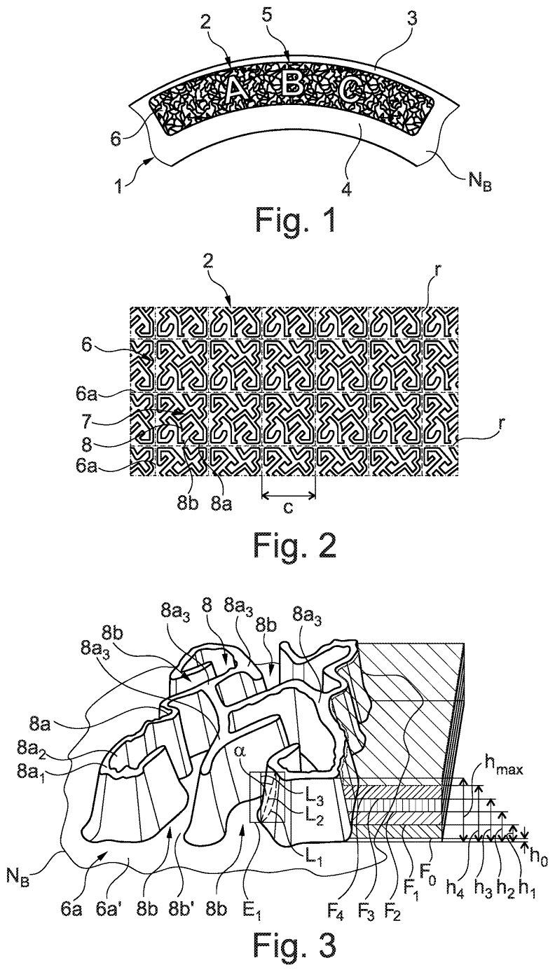

FIG. 1 shows a schematic illustration, projected into the plane, of a circumferential portion of a sidewall 1 having a surface element 2 which has substantially the shape of a segment of a circular ring. A tread edge 3 and an outer bead region 4, which are at least partially covered by a rim when the tire is mounted on the rim, are also shown. The surface element 2 surrounds lettering 5, the letters A B C of which have a smooth surface. The lettering 5 is thus not part of the surface element 2. In the exemplary embodiment, the base level NB is the level of the sidewall 1, i.e. the level of the outer surface of the sidewall 1.

FIG. 2 shows a schematic, enlarged plan view of a rectangular portion of the surface element 2 in the region outside the lettering 5, wherein a square grid (lattice) with grid lines r is marked. The surface element 2 has a peak-and-trough contrast structure 6 (see FIG. 1) covering the surface, i.e. over its entire extent, which imparts roughness, i.e. unevenness, to the surface element 2. As indicated by the square grid, the peak-and-trough contrast structure 6 comprises a plurality of substantially matching contrast structure cells 7 which, in the exemplary embodiment shown, in plan view are square in form with respect to their outer periphery and adjoin one another in the manner of a checkerboard. The contrast structure cells 7 have an edge length c, relative to an adjoining portion of a grid line r, of 700.0 μm to 1300.0 μm, in particular 800.0 μm to 1200.0 μm, in the exemplary embodiment 900.0 μm. The precise position or course of the grid lines r will be discussed below in more detail.

As will also be explained in more detail, each contrast structure cell 7 has an irregular peak-and-trough structure 8 (cf. FIG. 3), wherein the peak-and-trough structures 8—corresponding to the substantially matching contrast structure cells 7—are also designed substantially matching.

The phrases “substantially matching contrast structure cells 7” and “substantially matching peak-and-trough structures 8” are understood to mean firstly structures which were created directly on the outer surface of the tire (in the exemplary embodiment, on the sidewall) by means of a software-controlled laser so as to “match”. Secondly, the phrases “substantially matching contrast structure cells 7” and “substantially matching peak-and-trough structures 8” are understood to mean structures which were created during the vulcanization by a corresponding laser engraving located on the inside of the mold segment (in this exemplary embodiment, the side shell), wherein the laser engraving comprises a multiplicity of mutually adjoining engraving regions which were each created by means of a software-controlled laser so as to “match”. Because of the melting and evaporation processes that occur during laser engraving, it is not possible to create identical (100% matching) contrast structure cells 7, i.e. identical peak-and-trough structures 8, on the outer surface of vehicle tires with the currently available methods. This applies both to surface elements 2 produced indirectly by laser engraving of the mold parts, and also to surface elements 2 produced directly by laser engraving of the vulcanized rubber material. The phrase “substantially matching” therefore includes deviations that lie within the technical tolerance limits of the production process (software-controlled laser engraving).

As FIG. 2 furthermore shows, the peak-and-trough contrast structure 6 also has intersecting troughs 6a which run along the grid lines r and together form a lattice-like trough grid which is preferably identifiable with the naked eye.

The irregular peak-and-trough structure 8 of each contrast structure cell 7 is surrounded by the respective portions of the troughs 6a of the lattice-like trough grid in square form, wherein the part regions adjoining the respective grid lines r of the corresponding four troughs 6a are located within each contrast structure cell 7. The irregular peak-and-trough structure 8 is formed covering the surface within the associated contrast structure cell 7 such that the peak-and-trough structure 8 extends as far as the part regions of the respective four troughs 6a and therefore extensively adjoins these part regions. The precise meaning of the expression “peak-and-trough structure 8 covering the surface” will be described in more detail below.

The arrangement of the contrast structure cells 7 and the configuration of the irregular peak-and-trough structures 8 are such that, viewed from above, the irregular peak-and-trough structures 8 are transferable into one another by (twist-free) parallel displacement.

The further design of the contrast structure cells 7 is explained below with reference to a single contrast structure cell 7.

FIG. 3 shows a schematic, simplified oblique view of an irregular peak-and-trough structure 8 of a contrast structure cell 7 illustrated in an idealized form. The peak-and-trough structure 8 is formed by a single, cohesive, irregular, multiply branched peak structure 8a and by a number of troughs 8b which project from the troughs 6a of the trough grid surrounding the peak-and-trough structure 8 and end closed in the “interior” of the peak structure 8a (cf. FIG. 2). The troughs 8b are thus configured as “blind alleys”. Thus no trough basin (trough dish) forms which is surrounded (enclosed) by the portions of the peak structure 8a.

The peak structure 8a has a number of crossing points 8a₃ which are T-shaped or Y-shaped in top view, wherein the crossing points 8a₃ are the only crossing points of the peak structure 8a. In particular, the peak structure 8a has three to seven, in this exemplary embodiment five, T-shaped or Y-shaped crossing points 8a₃. The peak structure 8a furthermore has a maximum height hₘₐₓ (height at the highest point(s)), determined relative and perpendicularly to the base level N_{B}, of 200.0 μm to 400.0 μm, in this exemplary embodiment 280.0 μm.

The peak structure 8a also has a single peak saddle 8a₁ and a number of peak flanks 8a₂, wherein the peak flanks 8a₂ project from the peak saddle 8a₁, extend up to the base level N_{B} and converge at the free ends of the peak structure 8a, surrounding the latter.

The peak flanks 8a₂ are irregularly curved surfaces which are preferably free from kink points, wherein the slope of the surfaces relative to the base level NB increases with increasing distance from the base level N_{B}. The increase in slope of the peak flanks 8a₂ is in particular progressive such that the increase in slope takes place in accelerated fashion, thus starting from the base level N_{B} initially only slightly and then in ever stronger fashion. A section plane E₁, perpendicular to the base level N_{B}, in the region of a peak flank 8a₂ is indicated by way of example in FIG. 3. The section plane E₁ has a curved intersection line L₁ with the peak flank 8a₂ concerned, which line in particular curves exclusively in one direction and is therefore arcuate. The peak flank 8a₂ runs such that a straight auxiliary line L₂, connecting the ends of the intersection line L₁, encloses an angle a of 8° to 20° with a reference line L₃ that is perpendicular to the base level N_{B} and intersects the auxiliary line L₂. A multiplicity of section planes E₁ may be applied in the region of the peak flanks 8a₂, resulting in an angle a defining the slope of the peak flanks 8a₂ of 8° to 20°.

Preferably, at least one of the closed-end troughs 8b projects from each of at least two, in particular at least three, of the four troughs 6a. In the peak-and-trough structure 8 shown, two troughs 8b project from the trough 6a delimiting the peak structure 8a “at the front” in FIG. 3, a single trough 8b projects from the trough 6a delimiting the peak structure 8a “at the rear” in FIG. 3, another single trough 8b projects from the trough 6a delimiting the peak structure 8a “on the left” in FIG. 3, and no trough 8b projects from the trough 6a delimiting the peak structure 8a “on the right” in FIG. 3. As FIG. 2 in particular shows, viewed from above, starting from their end located at the respective trough 6a, the troughs 8b are irregularly elongate and in some cases branched negatives.

The above-mentioned idealized form of the illustrated irregular peak-and-trough structure 8 is characterized in that the peak saddle 8a₁ is a flat plateau and each trough 6a, 8b has a trough base 6a′ (trough 6a), 8b′ (trough 8b) running at the base level N_{B}. Because of said melting process during laser engraving however, both the peak saddle 8a₁ and also each trough base 6a', 8b′ have a degree of irregular roughness, so that the flat plateau of the peak saddle 8a₁ shown and also each trough base 6a', 8b′ are not flat surfaces but run or are situated at different levels relative to the base level NB. Both the peak saddle 8a₁ and also each trough base 6a', 8b′ thus have fine irregular protrusions (not shown). The trough bases 6a', 8b′ thus run substantially at base level NB and the peak saddle 8a₁ runs substantially at the level of the maximum height hₘₐₓ, wherein this expression will be defined in more detail below.

The further form of the irregular peak-and-trough structure 8 is explained below with reference to height surfaces F₀, F₁, F₂, F₃, F₄, which are indicated at the side of FIG. 3. The height surfaces F₀, F₁, F₂, F₃, F₄ extend parallel to the respective base level N_{B}, intersect the irregular peak-and-trough structure 8 and run at various heights h₀ (height surface F₀), h₁ (height surface F₁), h₂ (height surface F₂), h₃ (height surface F₃) and h₄ (height surface F₄) determined perpendicularly to the base level N_{B}.

The height surface F₀ serves to define the expression “run substantially at base level N_{B}”, to define the position of the grid lines r, and to define the expression “peak-and-trough structure 8 covering the surface”. The height h₀ belonging to the height surface F₀ is 30.0 μm.

A “trough base 6a', 8b′ running substantially at base level N_{B}” means one on which abovementioned fine irregular protrusions extend at most to the height surface F₀, i.e. end either at the height surface Fo or between the base level N_{B} and the height surface F₀. The associated trough 6, 8 is therefore free from fine irregular protrusions from the side of the height surface Fo facing away from the base level N_{B}.

The position of the grid lines r in the troughs 6a is such that the respective grid line r has matching distances, determined as minimum possible distances, from the peak structures 8a of the two contrast structure cells 7, determined in the height surface Fo, adjoining the respective trough 6a (not shown). These distances amount to 30.0 μm to 100.0 μm in an “irregular peak-and-trough structure 8 covering the surface (extending up to the grid-defining troughs 6a)”. In connection with the peak-and-trough structure 8, these distances also define the expression “covering the surface”.

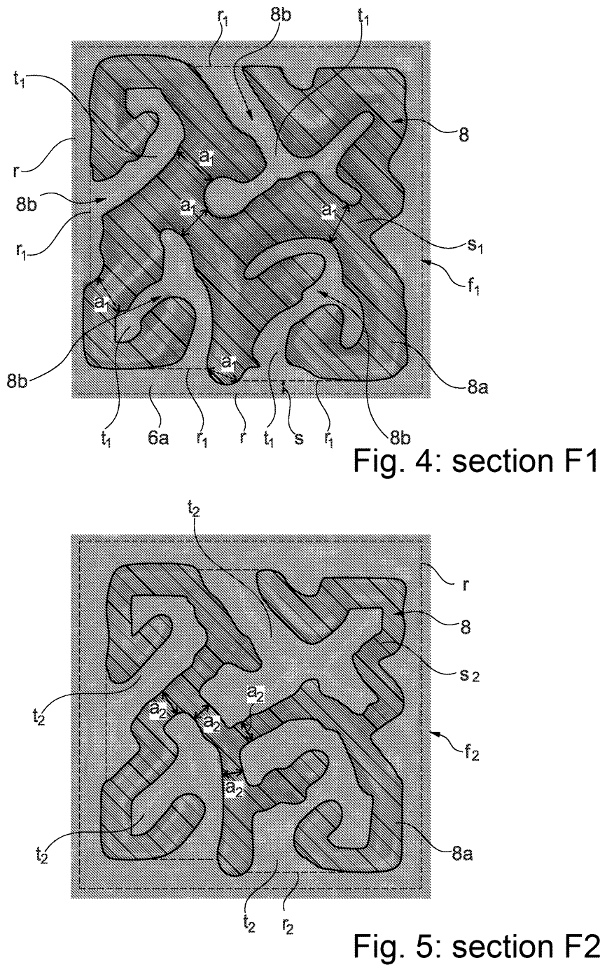

The height h₁ of the height surface F₁ amounts to 20% of the maximum height hₘₐₓ, the height h₂ of the height surface F₂ amounts to 40% of the maximum height hₘₐₓ, the height h₃ of the height surface F₃ amounts to 60% of the maximum height hₘₐₓ and the height h₄ of the height surface F₄ amounts to 80% of the maximum height hₘₐₓ. The height surfaces F₁, F₂, F₃ and F₄ in each contrast structure cell 7—corresponding to the edge length c (FIG. 2) of the contrast structure cell 7—have a height surface region f₁, f₂, f₃, f₄ measuring 900 μum*900 μm and delimited in top view by the corresponding portions of the respective grid lines r (see FIGS. 4 to 7).

As FIGS. 4 to 7 show, the irregular peak-and-trough structure 8 with the associated height surface region f₁, f₂, f₃, f₄ has a one-piece (cohesive) or multipiece section surface s₁, s₂, s₃, s₄ shown hatched in the figures. The section surface s₁, s₂, s₃, s₄ is thus part of the associated height surface region f₁, f₂, f₃, f₄. In the region of each section surface s₁, s₂, s₃, s₄, the peak structure 8a protrudes through the height surface region f₁, f₂, f₃, f₄.

According to FIG. 4, the section surface s₁ is of one piece and takes up 70% to 80% of the height surface region f₁. Each closed-ended trough 8b in the height surface region f₁ has a trough surface t₁ which adjoins the section surface s₁ and is “closed” by a grid parallel line r₁ running in the height surface region f₁ against the trough 6a from which the respective trough 8a protrudes. The trough surfaces t₁ are therefore parts of the height surface region f₁. The grid parallel line r₁ results from the minimum possible parallel shift of the grid line r running in the region of the trough 6a from which the trough 8b projects. The phrase “minimum possible parallel shift” means that the extent of the line s defining the extent of the parallel shift and measured perpendicular to the grid line r is as small as possible. The size of the largest trough surface t₁ is 105% to 170%, in particular at most 150%, preferably at most 130%, of the size of the smallest trough surface t₁. The mutually adjacent trough surfaces t₁ have the minimum possible straight measured distances a₁ from one another of 80.0 μm to 100.0 μm.

According to FIG. 5, the section surface s₂ is also one piece, wherein—as a comparison with FIG. 4 shows—the section surface s₂ is part of its “underlying” section surface s₁ and takes up 40% to 60% of the height surface region f₂. Each closed-ended trough 8b in the height surface region f₂ has a trough surface t₂ which adjoins the section surface s₂ and is delimited by a grid parallel line r₂ in the height surface region f₂ against the trough 6a from which the respective trough 8b protrudes. The grid parallel lines r₂ are defined similarly to the grid parallel lines r₁. The trough surfaces t₂ have the minimum possible straight measured distances a₂ from one another of 60.0 μm to 80.0 μm.

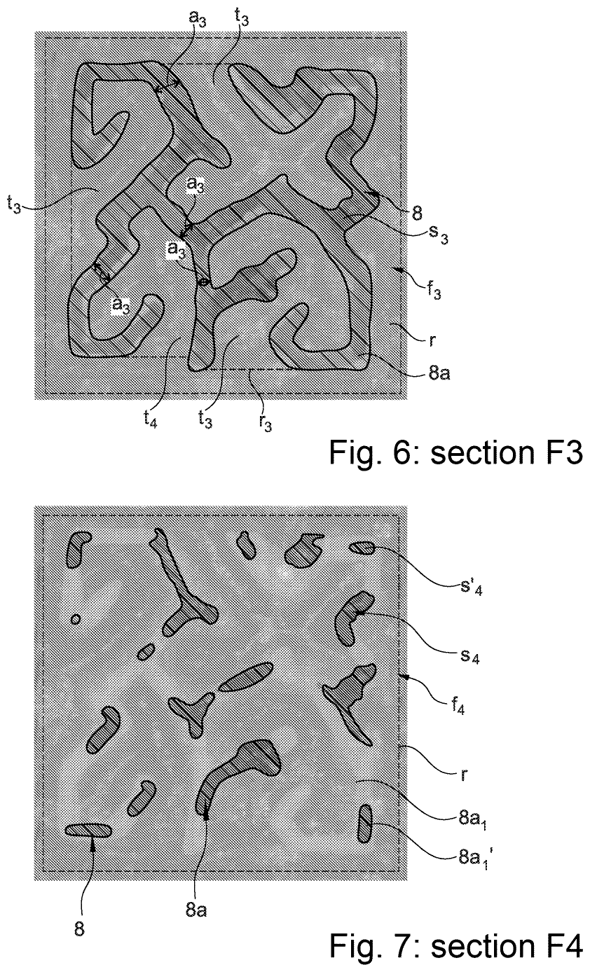

According to FIG. 6, the section surface s₃ is also one piece, wherein the section surface s₃ is part of its “underlying” section surface s₂ and takes up 20% to 30% of the height surface region f₃. Each closed-ended trough 8b in the height surface region f₃ has a trough surface t₃ co-delimited by a grid parallel line r₃ and determined similarly to trough surface t₁, t₂. The trough surfaces t₃ have the minimum possible straight measured distances a₃ from one another of 40.0 μm to 50.0 μm.

According to FIG. 7, the section surface s₄ is multi-piece, wherein the section surface s₄ is formed from in particular three to twenty, preferably thirteen to seventeen, mutually separate section surface parts s₄′, is part of its “underlying” section surface s₃, and takes up 5% to 15% of the height surface region f₄. Thus the relationship s₄<s₃<s₂<s₁ applies. Preferably, the relationships s₄≤0.7 s₃, s₃≤0.7 s₂ and s₂≤0.7 s₁ apply. The height surface region f₄ thus separates a number of peak saddle regions 8a₁′ of the peak saddle 8a₁ sitting on the section surface parts s₄′, i.e. adjoining these on the side facing away from the base level N_{B}, from the region of the peak structure 8a “underlying” the height surface F₄. A peak saddle region 8a₁′ is thus a cohesive region of the peak structure 8a.

The invention is not limited to the exemplary embodiment described.

The contrast structure cells may have a shape in top view which deviates from the shape described. Preferably, the contrast structure cells in top view are each delimited by a number of straight grid lines or grid line portions. Particularly preferably, the contrast structure cells have the shape of a regular polygon, in particular a square or regular hexagon. Furthermore, the contrast structure cells may in particular be rectangles or elongated hexagons. The irregular peak-and-trough structures of the contrast structure cells, viewed from above, can be transferred into one another by at least one congruent projection. The congruent projection includes in the known fashion reflective inversions (more precisely, local inversions and perpendicular axial inversions, not however cross inversions and oblique inversions), rotations, parallel shifts (translations) and slip inversions (push inversions). Therefore, contrast structure cells may be provided which can be transferred into one another by successively performing multiple different congruent projections. Also, contrast structure cells may be provided which can be transferred into one another by different and/or different combinations of congruent projections. For example, a first contrast structure cell can be transferred into a second contrast structure cell by a parallel shift, and the first contrast structure cell can be transferred to a third contrast structure cell by rotation.
1 [symbol] [symbol]
3 [symbol]
4 [symbol]
6 [symbol]
6a [symbol]
6a′ [symbol]
7 [symbol]
8 [symbol]
8a [symbol]
8a₁ [symbol]
8a₁′ [symbol]
8a₂ [symbol]
8a₃ [symbol]
8b [symbol]
8b′ [symbol] The invention relates to a pneumatic vehicle tire comprising at least one surface element formed on its outer surface with a peak-and-trough contrast structure formed relative to a base level and covering the surface.

The peak-and-trough contrast structure (6) is formed from a plurality of contrast structure cells (7) joined together in a grid pattern and having matching forms in top view,
wherein the peak-and-trough contrast structure has grid-defining troughs along the mutual connection points of the contrast structure cells,
wherein the contrast structure cells each have an irregular peak-and-trough structure which covers the surface, extends up to the grid-defining troughs and is made solely of a single cohesive branched peak structure and closed-ended troughs projecting from the grid-defining troughs,
wherein the arrangement of the contrast structure cells and the design of the irregular peak-and-trough structures are such that, viewed from above, the irregular peak-and-trough structures can be transferred into one another by congruent projection.

1-15. (canceled)

16. A pneumatic vehicle tire comprising:
at least one surface element formed on its outer surface with a peak-and-trough contrast structure formed relative to a base level and covering the surface,
wherein,
the peak-and-trough contrast structure is formed from a plurality of contrast structure cells joined together in a grid pattern and having matching forms in top view;
wherein the peak-and-trough contrast structure has grid-defining troughs along the mutual connection points of the contrast structure cells;
wherein the contrast structure cells each have an irregular peak-and-trough structure which covers the surface, extends up to the grid-defining troughs and is made solely of a single cohesive branched peak structure and closed-ended troughs projecting from the grid-defining troughs; and
wherein the arrangement of the contrast structure cells and the design of the irregular peak-and-trough structures are such that, viewed from above, the irregular peak-and-trough structures can be transferred into one another by congruent projection.

17. The pneumatic vehicle tire as claimed in claim 16, wherein the peak structure has exclusively crossing points at which portions of the peak structure coming from three directions meet one another.

18. The pneumatic vehicle tire as claimed in claim 17, wherein the crossing points are T-shaped or Y-shaped in top view.

19. The pneumatic vehicle tire as claimed in claim 17, wherein the peak structure has three to seven crossing points.

20. The pneumatic vehicle tire as claimed in claim 16, wherein in a top view, the contrast structure cells are each delimited by a number of straight grid lines or a number of straight portions of grid lines, wherein the grid lines or portions of grid lines run in the grid-defining troughs and wherein the contrast structure cells preferably each have an edge length relating to an adjoining grid line or adjoining portion of a grid line of 700.0 um to 1300.0 μm, in particular 800.0 μm to 1200.0 μm.

21. The pneumatic vehicle tire as claimed in claim 16, wherein the closed-ended troughs each project from a single grid-codefining trough.

22. The pneumatic vehicle tire as claimed in claim 16, wherein the peak-and-trough structure, with a height surface region extending over the contrast structure cell, of a height surface which extends parallel to the base level and lies relative thereto at a height of 20% of the maximum height of the peak structure determined perpendicularly to the base level, has a one-piece section surface which takes up 70% to 80% of the height surface region.

23. The pneumatic vehicle tire as claimed in claim 16, wherein the closed-ended troughs in the height surface region each have a trough surface which adjoins the one-piece section surface and is co-delimited, against the grid-codefining trough from which the respective closed-ended trough projects, by a grid parallel line resulting from a minimum possible parallel shift of the grid line which runs in the grid-codefining trough from which the respective closed-ended trough projects, wherein the size of the largest trough surface amounts to 105% to 170%, in particular maximum 150%, preferably maximum 130% of the size of the smallest trough surface.

24. The pneumatic vehicle tire as claimed in claim 23, wherein the trough surfaces have minimum possible straight measured distances from one another of 80.0 um to 100.0 um.

25. The pneumatic vehicle tire as claimed in claim 16, wherein the peak-and-trough structure, with a height surface region extending over the contrast structure cell, of a height surface which extends parallel to the base level and lies relative thereto at a height of 40% of the maximum height of the peak structure determined perpendicularly to the base level, has a one-piece section surface which takes up 40% to 60% of the height surface region.

26. The pneumatic vehicle tire as claimed in claim 25, wherein the closed-ended troughs in the height surface region each have a trough surface which adjoins the one-piece section surface and is co-delimited, against the grid-codefining trough from which the respective closed-ended trough projects, by a grid parallel line resulting from a minimum possible parallel shift of the grid line which runs in the grid-codefining trough from which the respective closed-ended trough projects, wherein the trough surfaces have minimum possible straight measured distances from one another of 60.0 μm to 80.0 μm.

27. The pneumatic vehicle tire as claimed in claim 16, wherein the peak-and-trough structure, with a height surface region extending over the contrast structure cell, of a height surface which extends parallel to the base level and lies relative thereto at a height of 60% of the maximum height of the peak structure determined perpendicularly to the base level, has a one-piece section surface which takes up 20% to 30% of the height surface region.

28. The pneumatic vehicle tire as claimed in claim 16, wherein the closed-ended troughs in the height surface region each have a trough surface which adjoins the one-piece section surface and is co-delimited, against the grid-codefining trough from which the respective closed-ended trough projects, by a grid parallel line resulting from a minimum possible parallel shift of the grid line which runs in the grid-codefining trough from which the respective closed-ended trough projects, wherein the trough surfaces have minimum possible straight measured distances from one another of 40.0 μm to 50.0 μm.

29. The pneumatic vehicle tire as claimed in claim 16, wherein the peak structure has a maximum height of 200.0 μm to 400.0 μm determined relative and perpendicular to the base level.

30. The pneumatic vehicle tire as claimed in claim 16, wherein the peak-and-trough structure has at least two, in particular at least three closed-ended troughs projecting from the grid-defining troughs.

31. A pneumatic vehicle tire comprising:
a sidewall connected to an edge of a tread and having an outer surface;
a surface element formed on the outer surface with a peak-and-trough contrast structure formed relative to a base level;
the contrast structure formed from a plurality of contrast structure cells joined in a grid pattern and having matching forms in a top view;
the contrast structure has grid-defining troughs along mutual connection points of the plurality of contrast structure cells;
the plurality of contrast structure cells each have an irregular peak-and-trough structure that covers a surface, extends up to the grid-defining troughs and solely consists of a single cohesive branched peak structure and closed-ended troughs projecting from the grid-defining troughs;
the single cohesive branched peak structure has a plurality of crossing points; and
the single cohesive branched peak structure has a peak saddle and one or more peak flanks, wherein the peak flanks project from the peak saddle up to the base level.

32. The tire of claim 31, wherein the crossing points are T-shaped.

33. The tire of claim 31, wherein the irregular peak-and-trough structures are such that, viewed from above, the irregular peak-and-trough structures can be transferred into one another by congruent projection.

34. The tire of claim 31, wherein the peak flanks are irregularly curved surfaces and free from kink points and a slop of surfaces relative to the base level increases with increasing distance from the base level.
